(19) United States
(12) Patent Application Publication
(10) Pub. No.: US 2025/0019272 A1
(43) Pub. Date: Jan. 16, 2025

(54) ROBUST ELECTROCATALYTIC REACTOR FOR THE REMEDIATION OF WASTEWATER

(71) Applicant: Rodney HERRING, Victoria (CA)

(72) Inventor: Rodney HERRING, Victoria (CA)

(21) Appl. No.: 18/350,417

(22) Filed: Jul. 11, 2023

(51) Int. Cl. C02F 1/461

(52) U.S. Cl. CPC C02F 1/46109; C02F 2001/46142; C02F 2201/4618; C02F 2209/29

(57) ABSTRACT

An electrocatalytic reactor is provided for use with a power source for remediating polluted water, the electrocatalytic reactor comprising: a first electrode which includes a titanium metal core, a titanium dioxide layer on the titanium metal core, which includes an outer surface and low iron oxide, iron doped titanium dioxide nanoparticles which are bound to the outer surface of the titanium dioxide layer; a second electrode which includes a titanium metal core, the second electrode in electrical communication with the first electrode; and a vessel in which the first electrode and the second electrode are housed, the vessel configured to at least transiently retain the polluted water.

### FIELD

The present technology is directed to a robust electrocatalytic reactor for remediating wastewater. More specifically, it is a method of electrocatalytically remediating wastewater in the dark with an electrocatalytic reactor which includes one electrode which is a combined electrode-electrocatalyst and has a low iron oxide, iron-doped titanium dioxide activated titanium dioxide surface and another electrode which includes titanium metal.

### BACKGROUND

Wastewater remediation generally requires a high-power input and very frequently relies on ultraviolet light. Wastewater treatment using TiO.sub.2 as a photocatalyst has attracted a great deal of attention because of its high activity, chemical stability, robustness against photo-corrosion, low toxicity, low pollution load, and availability at low cost. However, the shortcomings of conventional powder catalysts include low efficiency of light use, difficulty of stirring during reaction and separation after reaction (usually using ultra-filtration), and low-concentration contamination near TiO.sub.2 due to its low surface area.

United States Patent Application Publication No. 20210340034 discloses a water-disinfecting apparatus includes a vessel with a cathode, an insert with a photoanode, an ultraviolet light source configured to be positioned in the insert, and a power source. The cathode forms an electrically conductive layer on an inner surface of the vessel. The photoanode is configured to be positioned in the cathode. The power source is configured to be operably coupled to the cathode, the photoanode, and the light source.

United States Patent Application Publication No. 20200353448 discloses that catalysts for selective production of hydrogen peroxide and methods of making and using thereof have been developed. The catalysts include an alloyed or doped metal oxide which permits tuning of the catalytic properties of the catalysts for selection of a desired pathway to a product, such as hydrogen peroxide. The catalysts may be incorporated into electrochemical or photochemical devices. Titanium dioxide is disclosed as one potential catalyst.

U.S. patent application No. 20090301859 discloses that a reactor produces a surface corona for emitting UV light and for the production of ozone by passing air or oxygen through the surface corona. The emitted UV light activates a photocatalyst coated on a surface facing a surface with embedded electrodes which generate the surface corona. The photocatalyst is a thin film of nanoparticle TiO.sub.2 with primary particle size of 0.02 to 0.2.mu.m was deposited on a substrate by a flame aerosol method. The method combines ozonation and photocatalysis to provide effective and efficient oxidation of alcohols and hydrocarbons to value added products. The method can also be used for air and water cleaning. UV light does not penetrate a significant distance into liquid and does not pass through glass. Further, there is a high power requirement for UV lights.

The current methods used to perform TiO.sub.2 photocatalysis also include the application of UV onto a TiO.sub.2 surface coating in the presence of the target waste stream. There are three possible serious drawbacks of UV/TiO.sub.2 photocatalysis technology that has resulted in the failure of the technology to become established as a successful industrial wastewater treatment technology. Firstly, the ability of the UV to effectively penetrate waste stream which could be turbid, secondly the limited effect of the TiO.sub.2 catalyst due to the relatively small surface reaction area used in current systems, and thirdly UV has harmful effects on microbes. These drawbacks of TiO.sub.2 result in low efficiency of photocatalytic activity in practical applications.

http://www.mchnanosolutions.com/discloses the use of titanium dioxide for cleaning surfaces and decontamination of liquids. Their system is reliant upon ultraviolet (UV) light, which is expensive and which does not penetrate glass.

Other approaches focus on electrocatalysis. For example, United States Patent Application Publication No. 20180319680 discloses an electrolytic assembly and a method for the bacterial disinfection of water or wastewater. Water circulating in cooling towers such as those that discharge heat from air conditioning; ships' ballast water; or wastewater with a dryness varying from 0.01 to 3%; can be treated. The assembly comprises one or more electrolytic units comprising at least one Dimensionally Stable Anode commonly known as DSA, or a Boron Doped Diamond anode, also named BDD anode. The electrolytic treatment at least partially kill the bacteria present in the water. It has been shown that the electrolytic treatment breaks the cell membrane of bacteria present in the water. The treatment is particularly adapted for eliminating Legionella and others microorganisms, such as E. coli. Between 6V and 40V is applied in the electrolytic assembly. This approach does not remediate wastewater as it does not break down organic waste.

United States Patent Application Publication No. 20170247273 discloses a bio-electrochemical system (BES) and a method of in-situ production and removal of H.sub.20.sub.2 using such a bio-electrochemical system (BES). Further, the invention relates to a method for in-situ control of H.sub.20.sub.2 content in an aqueous system of advanced oxidation processes (AOPs) involving in-situ generation of hydroxyl radical (OH) by using such a bio-electrochemical system (BES) and to a method for treatment of wastewater and water disinfection. The bio-electrochemical system (BES) according to the invention comprises: —an aqueous cathode compartment comprising a first cathode and a second cathode, —an aqueous anode compartment comprising an anode at least partly covered in biofilm, wherein the first cathode is connected to a first circuit and the second cathode is connected to a second circuit, wherein the first and the second circuit are connected to the system by an external switch.

United States Patent Application Publication No. 20160355411 discloses a portable system for treatment of liquids, gases, or both using precise energy separation (PES) is described herein. The system includes a power generation component which charges one or more energy storage units and powers the PES component of the portable system. The PES component includes one or more energy of dissociation sources and the energy storage units power the sources to provide an effective amount, intensity, and frequency of a promoter energy to specifically dissociate one or more target bonds of the target molecule present in contaminated liquids, gases, or both. Optionally, the energy stored in the system can act as a supplementary or back up power source. Titanium dioxide as a catalyst or photocatalyst is disclosed. The voltage required is 50 to about 50000 Volts, or higher as needed.

United States Patent Application Publication No. 20160332902 discloses a photoelectrocatalytic oxidizing device having a photoanode being constructed from a conducting metal such as Ti as the support electrode. Alternatively, the photoanode is a composite electrode comprising a conducting metal such as Ti as the support electrode coated with a thin film of sintered nanoporous TiO.sub.2. The device is useful in methods for treating an aqueous solution such as groundwater, wastewater, drinking water, ballast water, aquarium water, and aquaculture water to reduce amounts of a contaminant. The method being directed at reducing the amount and concentration of contaminants in an aqueous solution comprising providing an aqueous solution comprising at least one contaminant, and, photoelectrocatalytically oxidizing the contaminant, wherein the contaminant is oxidized by a free radical produced by a photoanode constructed from an anatase polymorph of Ti, a rutile polymorph of Ti, or a nanoporous film of TiO.sub.2. The application discloses that the effective voltage range may be in the range of −1 V to +12 V. The light source, as would be known to one skilled in the art, is ultraviolet light.

United States Patent Application Publication No. 20150284267 discloses devices and methods of treating aqueous solutions to help remove or otherwise reduce levels, concentrations or amounts of one or more contaminants. The disclosure relates to a system and apparatus which is adapted to receive components including at least one counter electrode (e.g. cathode) and at least one photoelectrode (e.g. anode) provided or arranged around at least one UV light source, and/or receive, contain and/or circulate fluid or aqueous solution. Titanium dioxide is disclosed as being a foil on at least one of the photoelectrodes. UV light does not penetrate a significant distance into liquid and does not pass through glass. Further, there is a high power requirement for UV lights.

United States Patent Application Publication No. 20150136591 discloses electrolytically treating water through influent inlet arrangements for cavitation and one or more pairs of electrodes. The electrodes can provide continuous anodic and cathodic operation for treating water. The pressurized influent premixed with oxidant gas can be pumped into the reactor vessel through the mixing nozzles arranged radially along the circumference. The polarity of the current to the electrode can be periodically reversed at a set interval. An electro-catalytic paddle electrode can be used for the treatment of flowback and produced water. The paddle electrode can consist of alternate pentagonal flat plate electrodes separated by adjustable variable distance Teflon spacers. The paddle electrode is provided with a chemical coating capable of switching/reversing the polarity of anodes and cathodes at ultra-high frequencies under very high current flowing conditions thus making it more efficient, stable and durable under demanding field conditions. This application discloses the use of UV light to produce hydroperoxyl on the cathode. UV light does not penetrate a significant distance into liquid and does not pass through glass. Further, there is a high power requirement for UV lights.

United States Patent Application Publication No. 20150027879 discloses point of service devices and methods of treating aqueous solutions to help remove or otherwise reduce levels, concentrations or amounts of one or more contaminants. The disclosure relates to a system including an apparatus including a substantially self-contained housing or container which is adapted to receive components including at least one counter electrode (e.g. cathode) and at least one photoelectrode (e.g. anode) provided or arranged around at least one UV light source, and/or receive, contain and/or circulate fluid or aqueous solution. Titanium dioxide is disclosed as being a foil on at least one of the photoelectrodes. UV light does not penetrate a significant distance into liquid and does not pass through glass. Further, there is a high power requirement for UV lights.

United States Patent Application Publication No. 20120279872 discloses the marriage of photocatalytic degradation and electrochemical oxidation to provide wastewater remediation and water purification based on the use of bifunctional electrodes. The bifunctional electrode provides for combined photocatalytic and electrochemical wastewater remediation for removing any one or combination of organic chemical pollutants, inorganic chemical pollutants and microorganisms. The electrode includes an electronically conducting substrate having a photocatalyst applied to a portion of the surface, the photocatalyst having a bandgap energy (E.sub.g), and an electrocatalyst applied to another portion of the surface. Under illumination the photocatalyst produces electron-hole pairs which are separated by an anodic bias potential applied across the photocatalyst. The same bias is applied across the electrocatalyst. The application of the anodic potential bias not only greatly enhances the performance of the photocatalyst for photooxidation of pollutants at the photocatalyst, but also effectively drives electrochemical oxidation of pollutants at the electrocatalyst surface. UV light does not penetrate a significant distance into liquid and does not pass through glass. Further, there is a high power requirement for UV lights.

KR101862989 discloses photocatalysis of wastewater using iron oxide doped titanium dioxide on activated carbon fiber. The light used for photocatalysis is in both the visible spectrum and the ultraviolet spectrum. As has been demonstrated in PCT/CA2020/000011, iron oxide on the surface of iron oxide doped titanium dioxide reduces the efficiency of the doped titanium dioxide. UV light does not penetrate a significant distance into liquid and does not pass through glass. Further, there is a high power requirement for UV lights.

A low iron oxide, iron-doped titanium dioxide visible light photoreactor is disclosed in PCT/CA2020/000011. The photoreactor comprises: a fiberglass sheet, which includes fibers and interstitial spaces between the fibers; and a low iron oxide content, iron-doped titanium dioxide film on the fibers, the film containing about 0.5 atomic percent iron and an iron oxide content of less than about 0.075 atomic percent iron. The photoreactor may be configured as a tube with a light emitting diode housed therein, a cap at one end of the tube that has inlets to accept pressurized air and a plate at the other end of the tube, such that the air is forced through the photoreactor. The power requirement for the visible light is relatively high. Remediation, as measured by the degradation of methyl orange, took approximately 7.5 hours at ten volts to reach 50% degradation.

A method of remediating wastewater is disclosed in PCT/CA2021258214. The method comprises substantially submersing an electrocatalytic reactor in wastewater, the electrocatalytic reactor including an anode, which is mesh and defines a first bore, a filter layer, which is porous glass, carbon fiber or poly-paraphenylene terephthalamide, the filter layer including fibers and interstitial spaces between the fibers, an iron-doped titanium dioxide film on the fibers, the film including a surface that is substantially iron oxide free, the filter layer housed within the first bore and defining a second bore, a cathode, which is housed within the second bore, is mesh and defines an inner bore, and a perforated air tube housed within the inner bore; and providing at least a voltage of at least about 3 volts to the electrocatalytic reactor, in the absence of a light source, thereby remediating wastewater. The electrocatalytic reactor degraded 50% of the methyl orange in about 11 hours when running at 5 volts.

What is needed is an apparatus and method that does not require light to remediate wastewater and polluted water. It would be preferable if the power consumption was lower than that needed for photocatalysis. It would be preferable if the catalyst was inexpensive. It would be more preferable if it was highly reactive at low power levels. It would be preferable if it was robust. It would be preferable if the electrode was a combination of an electrode and an electrocatalyst.

### SUMMARY

The present technology is an apparatus and method that does not require light to remediate wastewater and polluted water. It has a low power requirement. The catalyst is inexpensive. It is highly reactive at low power levels. The electrocatalytic reactor is very robust. The anode is a combined electrode and electrocatalyst and is a solid substrate.

In one embodiment, an electrocatalytic reactor is provided for use with a power source for remediating polluted water, the electrocatalytic reactor comprising: a first electrode which includes a titanium metal core, a titanium dioxide layer on the titanium metal core, which includes an outer surface and low iron oxide, iron doped titanium dioxide nanoparticles which are bound to the outer surface of the titanium dioxide layer; a second electrode which includes a titanium metal core, the second electrode in electrical communication with the first electrode; and a vessel in which the first electrode and the second electrode are housed, the vessel configured to at least transiently retain the polluted water.

The electrocatalytic reactor may further comprise a tube which is at least partially housed in the vessel such that it is at least partially immersed in the polluted water and is in fluid communication with an ambient air supply or an oxygen supply.

The electrocatalytic reactor may further comprise a proton exchange member which is located between the first electrode and the second electrode.

In the electrocatalytic reactor, the second electrode may include a ruthenium coating over the titanium metal core.

In another embodiment, a method of remediating wastewater is provided, the method comprising:
selecting an electrocatalytic reactor which includes a first electrode which includes a titanium metal core, a titanium dioxide layer on the titanium metal core, which includes an outer surface and low iron oxide, iron doped titanium dioxide nanoparticles which are bound to the outer surface of the titanium dioxide layer; a second electrode which includes a titanium metal core, the second electrode in electrical communication with the first electrode; and a vessel in which the first electrode and the second electrode are housed, the vessel configured to at least transiently retain the waste water;
filling the electrocatalytic reactor with the wastewater; and
supplying a voltage to the electrocatalytic reactor.

The method may further comprise placing a proton exchange membrane between the first electrode and the second electrode prior to filling the electrocatalytic reactor, to provide a first electrode side of the vessel and a second electrode side of the vessel.

The method may further comprise adding a chloride source to the vessel of the electrocatalytic reactor.

The method may further comprise adding a chloride source to the first electrode side of the electrocatalytic reactor.

In the method, the chloride source may be sodium chloride.

In the method the chloride source may be added to a concentration of between 200 parts per million and 2000 parts per million.

### BRIE DESCRIPTION OF THE DRAWINGS

FIG. 1 is a schematic of the electrocatalytic reactor of the present technology.

FIG. 2 is a close-up schematic of the anode of the reactor of FIG. 1.

FIG. 3 is a graph demonstrating the increased electrocatalytic activity of the electrocatalytic reactor of the present technology over an electrocatalytic reactor that has sintered titanium dioxide on a titanium metal core.

FIG. 4 is a schematic of alternative embodiment of FIG. 1.

FIGS. 5A-5D are graphs demonstrating the increased electrocatalytic activity of the electrocatalytic reactor of the alternative embodiment of FIG. 4 over an electrocatalytic reactor that lacks the proton exchange membrane. FIGS. 5A and 5B show the results when 200 ppm sodium chloride is added to the aqueous solution within the electrocatalytic reactor; and FIGS. 5C and 5D show the results when 1800 ppm sodium chloride is added to the aqueous solution within the electrocatalytic reactor.

FIG. 6 is a schematic of an alternative embodiment of FIG. 4, wherein chloride containing compounds were mixed in the solution around the anode and not the cathode.

### DESCRIPTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

### Definitions

Physical vapour deposition—in the context of the present technology, physical vapour deposition includes, but is not limited to, magnetron sputtering, ion beam sputtering, reactive sputtering, ion assist deposition, high target utilization sputtering, pulsed laser deposition and gas flow sputtering.

Thin film—in the context of the present technology, a thin film is up to 5 microns in thickness. A film may be a partial coating, a deposit upon a surface, a complete coating or a plurality of layers. To be clear, gaps may occur where the surface below is exposed. It may be formed by, for example, but not limited to growing nanocrystals on the substrate, physical vapour deposition on the substrate or photolithography on the substrate.

Iron-doped titanium dioxide with a low iron oxide surface—in the context of the present technology, iron-doped titanium dioxide with a low iron oxide surface has about 0.1 atomic % iron to about 2.0 atomic % iron, preferably 0.25 atomic % iron to about 0.75 atomic % iron, and more preferably 0.5 atomic % iron and very small amounts of iron oxide on its surface (less than 5% of the surface being iron oxide) when viewed with X-ray photoelectron spectroscopy.

Substantially iron oxide free surface—in the context of the present technology, a substantially iron oxide free surface has an iron oxide content corresponding to less than about 0.001% atomic iron (less than 0.5% of the surface being iron oxide) when viewed with X-ray photoelectron spectroscopy.

Vessel—in the context of the present technology, a vessel is a pipe, a holding tank, a cistern, a septic tank, a pond and the like.

### DETAILED DESCRIPTION

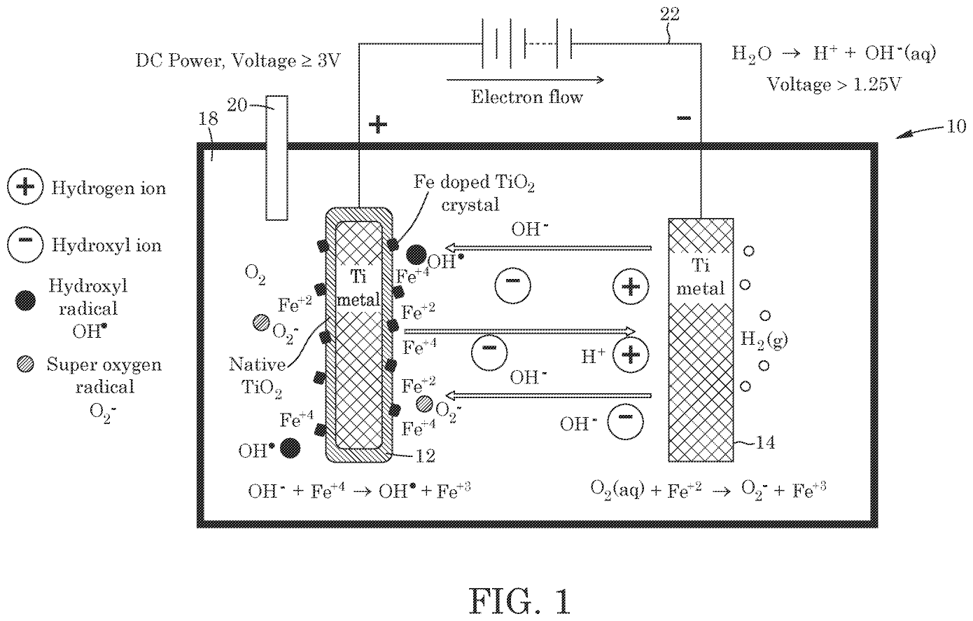

As shown in FIG. 1, the electrocatalytic reactor, generally referred to as 10 comprises has an anode 12 and a cathode 14 which are housed in a vessel 16. The vessel transiently retains wastewater or polluted water 18 in which the anode 12 and cathode 14 are at least partially immersed. A tube 20 for delivering oxygen or air is at least partially immersed in the aqueous environment 18. The oxygen or the oxygen in the air is provided so that the electrocatalytic reactor 10 can produce super oxygen radicals. The anode 12 and the cathode 14 are in electrical communication with a power source 22 and to one another via an electrical connection 24. The anode 12 and the cathode 14 can be placed very close together, for example, but not limited to about 1 millimeter apart. The cathode 14 is a titanium metal cathode which is coated with ruthenium. The titanium has lower electrical resistance than steel, hence the current remains higher, leading to better remediation of wastewater (which is highly current dependent). The ruthenium coating also maintains a high current while reducing corrosion. Both the titanium and the ruthenium lead to production of smaller hydrogen bubbles than were produced by steel electrodes. These small bubbles were found to trap micro and nano plastics, thus further increasing the utility of the electrocatalytic reactor 10.

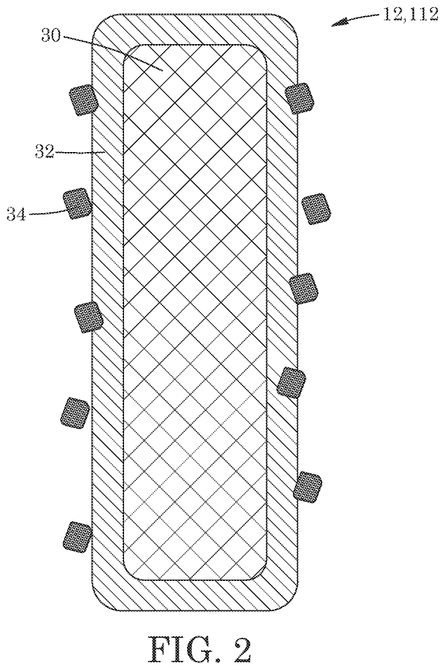

As shown in FIG. 2, the anode 12 has a titanium metal core 30 which is at least partially coated with a titanium dioxide layer 32. The titanium dioxide layer 30 is produced on the titanium metal core 30 by heating the titanium metal core 30 in air at about 600° C. for one hour, which produces a titanium oxide layer with a thickness of about 500 nanometers. Attached to the titanium dioxide layer 32 are low iron oxide, iron doped titanium dioxide nanoparticles 34. The low iron oxide, iron doped titanium dioxide nanoparticles form a continuous or discontinuous film. The film has a thickness of up to about 5 microns on the titanium dioxide layer 32. The film is low iron oxide, or substantially iron oxide free, iron-doped titanium dioxide and preferably contains about 0.5 atomic % iron. In the preferred embodiment, the film is discontinuous and is nanocrystals of low iron oxide, or substantially iron oxide free, iron-doped titanium dioxide. More specifically, the surface of the film is low iron oxide or substantially iron oxide free. Without being bound to theory, the titanium oxide layer is needed in order for the nanoparticles to bind strongly, as binding between the titanium metal core and the nanoparticles is weak. The anode is referred to as a Ti/TiO2/low iron oxide, Fe doped TiO2 nanoparticle anode.

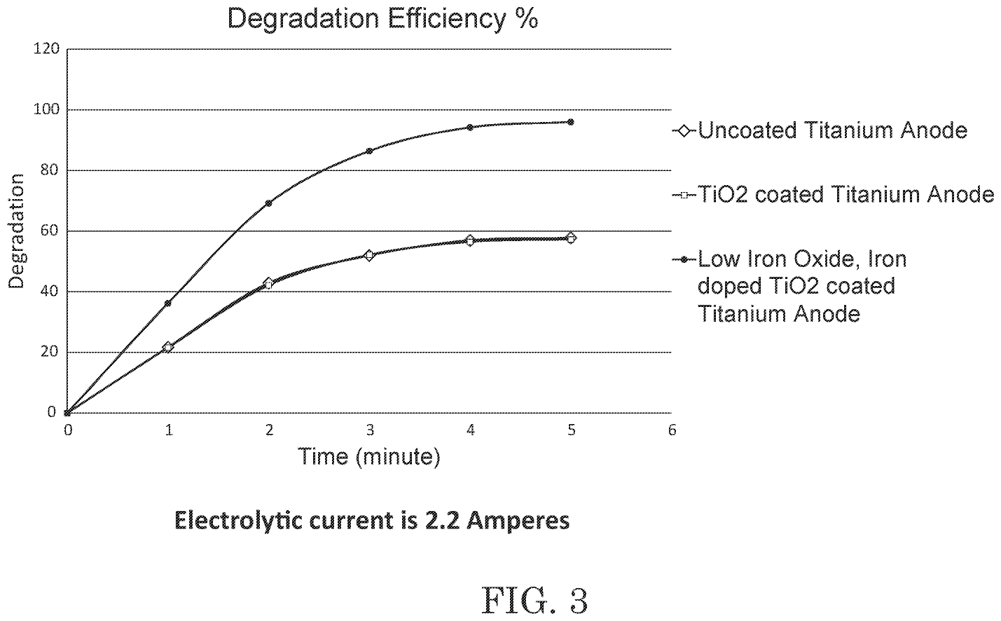

As shown in FIG. 3 the electrocatalytic reactor 10 with a Ti/TiO2/low iron oxide, Fe doped TiO2 nanoparticle anode and titanium cathode degrades methyl orange about 40% faster than an electrode with a titanium anode and titanium cathode or an electrode with a titanium/titanium dioxide anode and titanium cathode. Without being bound to theory, this is assumed to be because the titanium anode and the titanium dioxide anode have high recombination rates of the electrons and holes created during passage of electric current through them whereas the Ti/TiO2/low iron oxide, Fe doped TiO2 nanoparticle anode surface has lower recombination rates of the electrons and holes due to the presence of iron and consequently has a higher degradation efficiency. Fifty percent degradation occurred in under two minutes, and in close to 90 seconds when the electrocatalytic reactor 10 was run at 2.2 amperes and 3 volts.

This electrocatalytic reactor 10 is more efficient than one employing low iron oxide iron doped activated fibreglass cloth between the electrodes because the electrodes can be made very close to each other, ˜1 mm, so that a low voltage (˜10 V) with a high current (˜5 A) or low power condition can be applied by this electrocatalytic reactor 10.

Additionally, the electric current more easily passes through the titanium dioxide layer and the low iron oxide, iron doped titanium dioxide nanoparticles (less resistance), which are considered semiconductors having a bandgap of 0.3 eV, than when passing through the fibreglass cloth, which is a dialectic having a bandgap of 1.75 eV. This enables degradation of pollutants by this electrocatalytic reactor 10, to be conducted using lower power conditions than fibreglass cloth-based reactors.

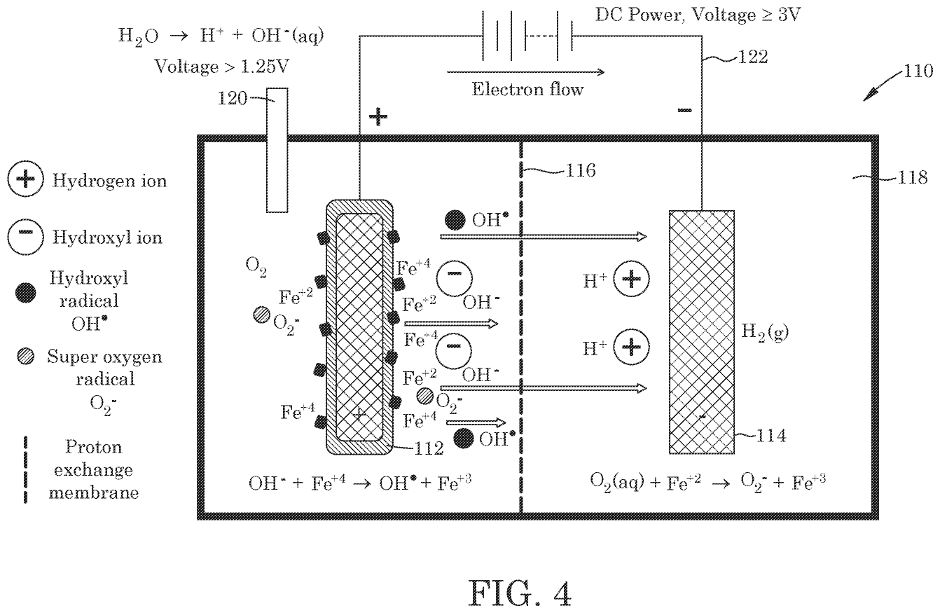

As shown in FIG. 4, in an alternative embodiment, the electrocatalytic reactor, generally referred to as 110 has an anode 112 and a cathode 114, separated by a proton exchange membrane 116 which are all immersed in an aqueous environment 118 that is at least transiently retained in a vessel 16. The proton exchange membrane in one embodiment is Nafion™ 211. A tube 120 for delivering oxygen or air is at least partially immersed in the aqueous environment (water needing to be cleaned) 118. It is in fluid communication with the ambient air or an oxygen source via a pump. The oxygen or the oxygen in the air is provided so that the electrocatalytic reactor 10 can produce super oxygen radicals. The anode 112 and the cathode 114 are in electrical communication with a power source 122 and one another via an electrical connection 124. The anode 112 and the cathode 114 can be placed very close together, for example, but not limited to about 1 millimeter apart. The cathode 114 is a titanium metal cathode which is coated with ruthenium. The titanium has lower electrical resistance than steel, hence the current remains higher, leading to better remediation of wastewater (which is highly current dependent). The ruthenium coating also maintains a high current while reducing corrosion. The ruthenium coating can be used on the cathode 14 of the first embodiment. Both the titanium and the ruthenium lead to production of smaller hydrogen bubbles than were produced by steel electrodes. These small bubbles were found to trap micro and nano plastics, thus further increasing the utility of the electrocatalytic reactor 110.

As shown in FIG. 2, the anode 112 has a titanium metal core 30 which is at least partially coated with a titanium dioxide layer 32. Attached to the titanium dioxide layer 32 are low iron oxide, iron doped titanium dioxide nanoparticles 34. The anode is referred to as a Ti/TiO2/low iron oxide, Fe doped TiO2 nanoparticle anode.

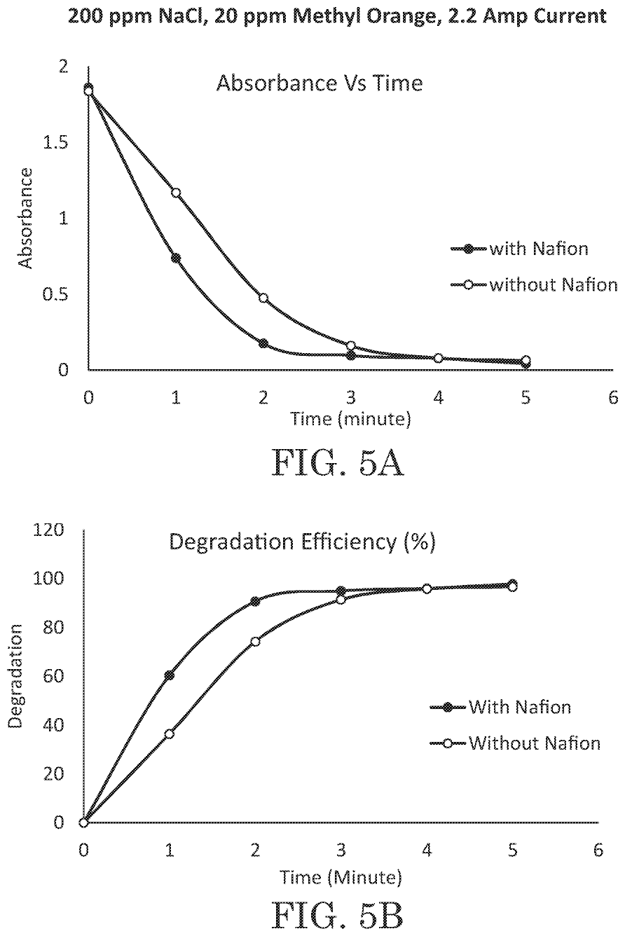

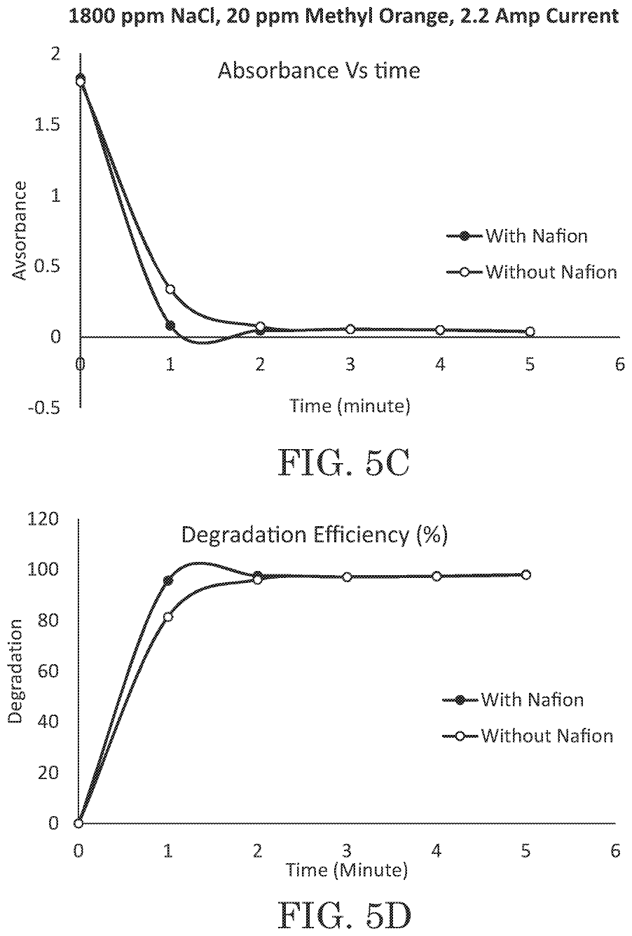

As shown in FIGS. 5A-5D, the proton exchange membrane 116 in the electrocatalytic reactor 110 doubled the rate of methyl orange degradation. It can also be seen that increasing the sodium chloride content in the aqueous solution 118 in the electrocatalytic reactor 110 from 200 part per million to 1800 parts per million also increased the rate of degradation. This was about a three-fold increase in the degradation rate. Accordingly, the sodium chloride content can range from 200 parts per million to 1800 parts per million, and as high as 2000 parts per million. Note that the proton exchange membrane 116 creates more resistance to the current flow at 2.2 amperes, hence the voltage increased to a 1 volt higher potential.

The proton exchange membrane 116 in the electrocatalytic reactor 110 was also shown to enhance the formation of OH: by about 17%.

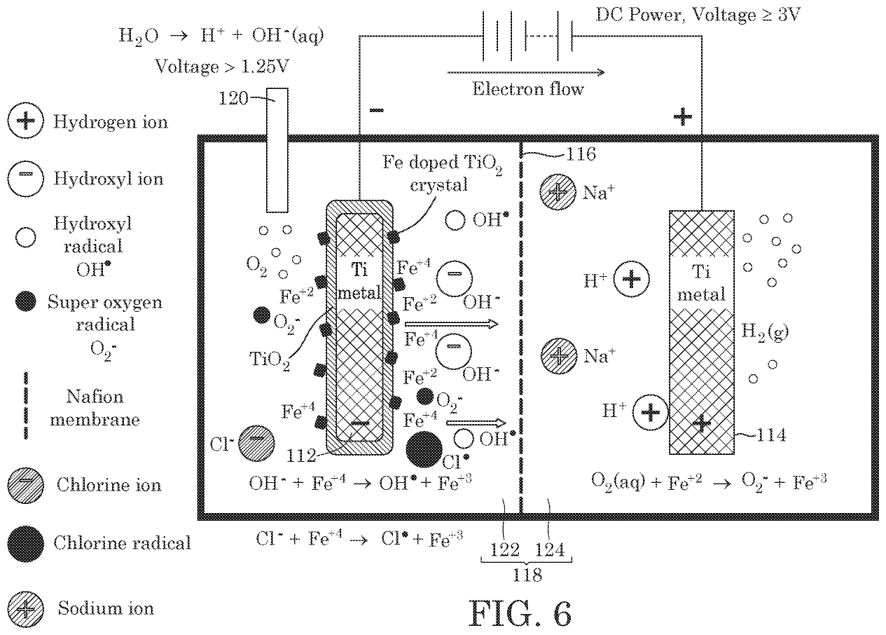

As shown in FIG. 6 in another embodiment, a chloride (Cl—) source such as NaCl, HCl or NaOCl was added to the solution around the anode 112 (the first electrode side 122) and not around the cathode 114 (the second electrode side 124). The CI— ion is blocked from passing to the cathode by means of the proton exchange membrane 116 whereas the positive Na+ ions are allowed to pass through. This has a couple of practicable applications. One is that it enhances the current or reduces the voltage/power required to run the reactor and the degradation rate of pollutants is dependent on the current. The other is that the CI-ion is oxidized to a radical CI: by reacting with the positive hole provided by the Fe+4 crystal ion on the surface stripping off CI-'s negative charge. This should enhance degradation of pollutants and disinfecting germs/coliforms in solutions. This application of the chloride source is different than using salt within the entire solution as was done in FIGS. 5A-D.

Increasing the amperage increases the rate of degradation of methyl orange for all embodiments. The range studied was from 2 amps to 16 amps (2, 4, 6, 8 and 16 amps).

The total volume of the electrocatalytic reactors 10, 110 can be scaled. The area ratio between the cathode 14, 114 and the anode 12, 112 is variable, however, in general the ratio is preferably about 1:1. As the size of the electrocatalytic reactor 10 increases the ratio approaches the theoretical limit of 1:1 where the area of the anode equals the area of the cathode. While the figures show the cathode 14, 114 and the anode 12, 112 as being rectangular, they may have a cross section that is, for example, but not limited to tubular, cylindrical, round, square, octagonal, hexagonal, elliptical or combinations thereof.

One method of preparing the low iron oxide, iron-doped titanium dioxide functionalized titanium dioxide-titanium metal anode is as follows:

The iron-doped titanium dioxide nanoparticles were prepared by the sol-gel method using titanium isopropoxide (TTIP) as the precursor and ferric nitrate (Fe(NO₃)3.9H2O) as the iron source. Firstly, the desired amount of ferric nitrate (0.25, 0.5, 1, 5 and 10 molar %) was dissolved in water and then the solution was added to 30 mL of anhydrous ethyl alcohol and stirred for 10 minutes. The acidity of the solution was adjusted to about pH 3 (about pH 2.5 to about pH 3.5) using HNO3 (other acids could also be used), which produces better Fe doped TiO2, i.e., incorporation of Fe into the TiO2 nanocrystals. Secondly, TTIP was added dropwise to the solution. Then deionized water with the ratio of Ti: H2O (1:4) was added to the mixture. The solution was stirred for two hours, poured onto the titanium dioxide-titanium metal anode and then dried at 80° C. to form particles on the titanium dioxide-titanium metal anode. The combination of the particles and the titanium dioxide-titanium metal anode was then washed three times with deionized water. Next, the combination was calcined at 400° C. for one hour to adhere the iron-doped titanium dioxide nanoparticles to the titanium dioxide-titanium metal anode, thus producing a functionalized titanium dioxide-titanium metal anode. The functionalized titanium dioxide-titanium metal anode was washed in an HCl solution (acid washed) and then washed with deionized water three times. The acid washing was in a solution of about pH 2.5 to about pH 3.5, or about pH 4, with, preferably, a monoprotic acid, such as, for example, but not limited to acetic acid (CH3CO2H or HOAc), hydrochloric acid (HCl), hydroiodic acid (HI), hydrobromic acid (HBr), perchloric acid (HClO4), nitric acid (HNO3) or sulfuric acid (H2SO4), with HCl being the preferred. Through analysis, it was shown that the nanoparticles bind to the titanium dioxide-titanium metal anode.

A second method of preparing the low iron oxide, iron-doped titanium dioxide functionalized titanium dioxide-titanium metal anode is as follows:

The low iron oxide, iron-doped titanium dioxide nanoparticles were prepared by the sol-gel method using titanium isopropoxide (TTIP) as the precursor and ferric nitrate (Fe (NO₃)3.9H₂O) as the iron source. Firstly, the desired amount of ferric nitrate (0.25, 0.5, 1, 5 and 10 molar %) was dissolved in water and then the solution was added to 30 mL of anhydrous ethyl alcohol and stirred for 10 minutes. The acidity of the solution was adjusted to about pH 3 (about pH 2.5 to about pH 3.5) using HNO₃ (other acids could also be used), which produces better Fe doped TiO₂, i.e., incorporation of Fe into the TiO₂ nanocrystals. Secondly, TTIP was added dropwise to the solution. Then deionized water with the ratio of Ti: H₂O (1:4) was added to the mixture. The solution was stirred for two hours and then dried at 80° C. for two hours.

The powders were then washed three times with deionized water. Next, the powder was calcined at 400° C. for three hours. The calcined powder was stirred in an HCl solution (acid washed) and then washed with deionized water three times. The acid washing was in a solution of about pH 2.5 to about pH 3.5, or about pH 4, with, preferably, a monoprotic acid, such as, for example, but not limited to acetic acid (CH₃CO₂H or HOAc), hydrochloric acid (HCl), hydroiodic acid (HI), hydrobromic acid (HBr), perchloric acid (HClO₄), nitric acid (HNO₃) or sulfuric acid (H₂SO₄), with HCl being the preferred. The acid washing produced low iron oxide, iron-doped titanium dioxide. The low iron oxide, iron-doped titanium dioxide nanoparticles were suspended in water and either sprayed onto the titanium dioxide-titanium metal anode or the titanium dioxide-titanium metal anode was immersed in the water. The combination of the titanium dioxide-titanium metal anode and the low iron oxide, iron-doped titanium dioxide nanoparticles was calcined at 400° C. for four hours to adhere the low iron oxide, iron-doped titanium dioxide nanoparticles to the titanium dioxide-titanium metal anode, thus producing a functionalized titanium dioxide-titanium metal anode. Through analysis, it was shown that the nanoparticles bind to the titanium dioxide-titanium metal anode.

Regardless of the method of producing the low iron oxide, iron-doped titanium dioxide nanoparticles, the acid washing was shown to remove a significant amount of iron oxide from the surface of the nanoparticles. The acid-washed iron-doped titanium dioxide nanoparticles function as catalysts under visible light.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1. An electrocatalytic reactor for use with a power source for remediating polluted water, the electrocatalytic reactor comprising: a first electrode which includes a titanium metal core, a titanium dioxide layer on the titanium metal core, which includes an outer surface and low iron oxide, iron doped titanium dioxide nanoparticles which are bound to the outer surface of the titanium dioxide layer; a second electrode which includes a titanium metal core, the second electrode in electrical communication with the first electrode; and a vessel in which the first electrode and the second electrode are housed, the vessel configured to at least transiently retain the polluted water.

2. The electrocatalytic reactor of claim 1, further comprising a tube which is at least partially housed in the vessel such that it is at least partially immersed in the polluted water and is in fluid communication with an ambient air supply or an oxygen supply.

3. The electrocatalytic reactor of claim 2, further comprising a proton exchange member which is located between the first electrode and the second electrode.

4. The electrocatalytic reactor of claim 3, wherein the second electrode includes a ruthenium coating over the titanium metal core.

5. A method of remediating wastewater, the method comprising:
selecting an electrocatalytic reactor which includes a first electrode which includes a titanium metal core, a titanium dioxide layer on the titanium metal core, which includes an outer surface and low iron oxide, iron doped titanium dioxide nanoparticles which are bound to the outer surface of the titanium dioxide layer; a second electrode which includes a titanium metal core, the second electrode in electrical communication with the first electrode; and a vessel in which the first electrode and the second electrode are housed, the vessel configured to at least transiently retain the waste water;
filling the electrocatalytic reactor with the wastewater; and
supplying a voltage to the electrocatalytic reactor.

6. The method of claim 5, further comprising placing a proton exchange membrane between the first electrode and the second electrode prior to filling the electrocatalytic reactor, to provide a first electrode side of the vessel and a second electrode side of the vessel.

7. The method of claim 6, further comprising adding a chloride source to the vessel of the electrocatalytic reactor.

8. The method of claim 6, further comprising adding a chloride source to the first electrode side of the electrocatalytic reactor.

9. The method of claim 8 wherein the chloride source is sodium chloride.

10. The method of claim 9, wherein the chloride source is added to a concentration of between 200 parts per million and 2000 parts per million.
